(19) United States
(12) Patent Application Publication
(10) Pub. No.: US 2026/0147543 A1
(43) Pub. Date: May 28, 2026

(54) SPLITTING APPLICATION INTO MICROSERVICES USING LARGE LANGUAGE MODEL

(71) Applicant: SAP SE, Walldorf (DE)

(72) Inventor: Hui Li, Shanghai (CN)

(21) Appl. No.: 18/960,323

(22) Filed: Nov. 26, 2024

(51) Int. Cl. G06F 8/30; G06F 18/23213

(52) U.S. Cl. CPC G06F 8/31; G06F 18/23213

(57) ABSTRACT

In an example embodiment, an embedding machine learning model is used to effectively and efficiently split a monolithic application into microservice. The embedding machine learning model is used to group the domain managers into multiple group, making sure that the semantic coupling among domain managers in the same group is the most and the semantic coupling among domain managers in different groups is the least. Once these groups have been form, the entities of the persistence layer are then assigned to corresponding groups, making sure that the semantic coupling between the domain layer and the persistence layer in the same group is the largest.

### RELATED APPLICATIONS

This application is related to SAP reference no. 240036US01 (SLW Dkt No. 2058.H05US1), entitled: “SPLITTING MONOLITHIC WITH LAYERED ARCHITECTURE INTO MICROSERVICES,” the disclosure of which is hereby incorporated by reference in its entirety.

### TECHNICAL FIELD

This document generally relates to computer systems. More specifically, this document relates to use of a large language models for splitting an application into microservices.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a diagram illustrating a layered architecture of a software system, in accordance with an example embodiment.

FIG. 2 is a diagram illustrating a system for splitting a monolithic application into multiple microservices, in accordance with an example embodiment.

FIG. 3 is a screen capture illustrating a user interface for modifying groups of domain managers and entities, in accordance with an example embodiment.

FIG. 4 is a flow diagram illustrating a method for splitting an application in accordance with an example embodiment.

FIG. 5 is a block diagram illustrating a software architecture in accordance with an example embodiment.

FIG. 6 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

A software system may be organized as a monolithic system using layered architecture. A layered architecture pattern is an n-tiered pattern where components are organized in horizontal method. All the components are interconnected but do not depend on one another.

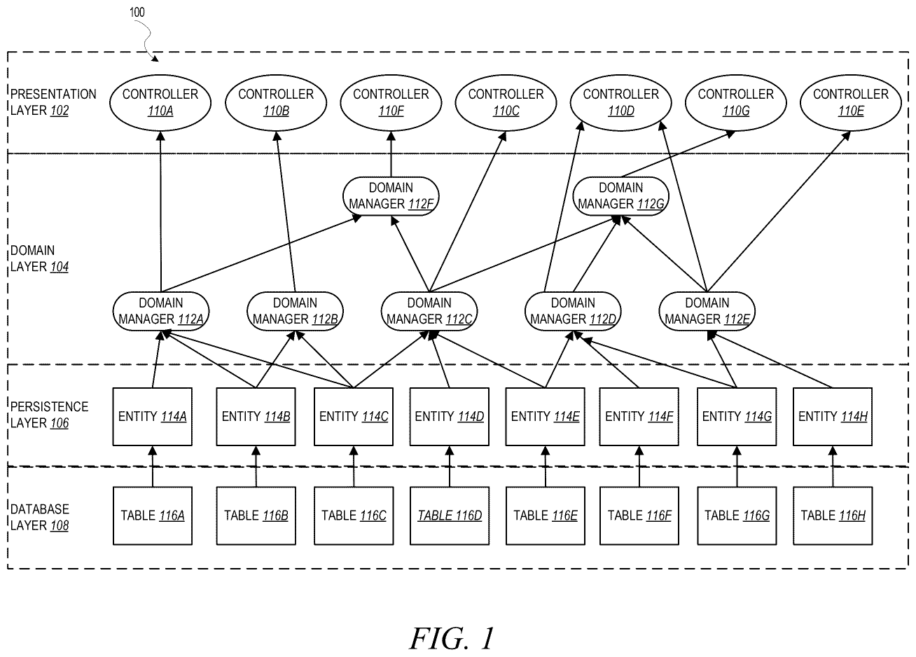

FIG. 1 is a diagram illustrating a layered architecture of a software system 100, in accordance with an example embodiment. Here, the layered architecture is broken into four layers: a presentation layer 102, a domain layer 104, a persistence layer 106, and a database layer 108. The presentation layer 102 handles interactions that users have with the system 100. It is the most visible layer and defines the application's overall look and presentation to the end-users. It is organized into multiple controllers 110A, 110B, 110C, 110D, 110E, 110F, 110G, each of which is a software process controlling some aspect of user interaction.

The domain layer 104 is where the main portions of the application logic reside. It comprises multiple domain managers 112A, 112B, 112C, 112D, 112E, 112F, 112G, each of which include rules that tell the system 100 how to run the application. The domain layer 104 essentially determines the behavior of the application. After one action finishes, it tells the application what to do next. Each controller 110A, 110B, 110C, 110D, 110E, 110F, 110G calls a corresponding domain manager 112A, 112B, 112C, 112D, 112E, 112F, 112G.

The persistence layer 106 acts as a protective layer. It contains the code that is needed to access the database layer. This layer also holds the code that allows for the manipulation of various aspects of the database, such as connection details and Structured Query Language (SQL) statements. It handles functions such as object-relational mapping, specifically when the underlying database is a relational database. It comprises multiple entities 114A, 114B, 114C, 114D, 114E, 114F, 114G, 114H.

The database layer 108 is where the data is stored. It comprises multiple tables 116A, 116B, 116C, 116D, 116E, 116F, 116G, 116H where the data is stored. Each entity 114A, 114B, 114C, 114D, 114E, 114F, 114G, 114H is mapped to a single table 116A, 116B, 116C, 116D, 116E, 116F, 116G, 116H. Each entity 114A, 114B, 114C, 114D, 114E, 114F, 114G, 114H contains the Create, Read, Update, and Delete (CRUD) interfaces for its corresponding table 116A, 116B, 116C, 116D, 116E, 116F, 116G, 116H.

Recently, however, more and more layered architecture monolithic systems are migrating to microservices. Microservices are small, independent software processes that can be written in multiple languages. An infrastructure designed for these modular components is known as a microservices environment or microservices architecture. Cloud environments may be used to implement microservices environments. An example of a microservices environment is SAP Cloud Platform® Extension Manager, from SAP SE of Walldorf, Germany. Another example is Cloud Application Lifecycle Management (CALM)®, from SAP SE of Walldorf, Germany.

Microservices often communicate with each other via remote call, such as by using Hypertext Transfer Protocol (HTTP) or g Remote Procedure Call (gRPC) calls. Sometimes microservices are dependent on other microservices.

Engineers will split the monolithic system into the microservices based on estimation. This estimation, however, lacks quantitative analysis, and thus how the monolithic system is split into microservices may not be effective or efficient. Additionally, engineers often split the monolithic system into microservices based on traffic data and logs among different modules. However, some monolithic systems are not monitored well and thus there is not enough traffic data or logs to effectively perform the splitting into microservices.

In an example embodiment, an embedding machine learning model is used to effectively and efficiently split a monolithic application into microservice. The embedding machine learning model is used to group the domain managers into multiple groups, making sure that the semantic coupling among domain managers (how closely related are the texts about the domain managers) in the same group is the most and the semantic coupling among domain managers in different groups is the least. Once these groups have been formed, the entities of the persistence layer are then assigned to corresponding groups, making sure that the semantic coupling between the domain layer and the persistence layer in the same group is the largest.

An embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector, and the texts with similar semantics will have the corresponding similar embeddings.

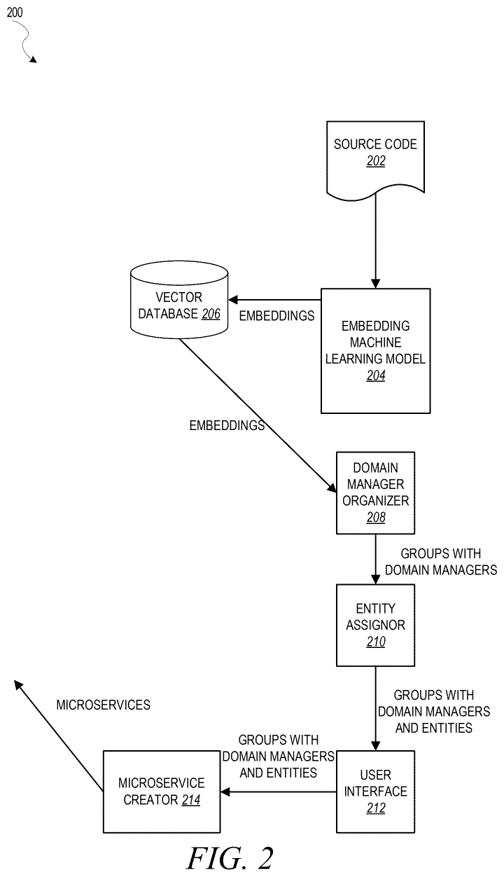

FIG. 2 is a diagram illustrating a system 200 for splitting a monolithic application into multiple microservices, in accordance with an example embodiment. Source code 202 for the application is fed to an embedding machine learning model 204, which embeds the source code files into embeddings. More particularly, each domain manager and entity are fed into the embedding machine learning model 204 so that the embedding machine learning model 204 generates a separate embedding for each domain manager or entity. These embeddings reflect the position of the corresponding piece of source code in a high-dimensional semantic space, meaning that the proximity of embeddings to one another in the high-dimensional semantic space is reflective of the similarity of the corresponding pieces of source code.

The embedding machine learning model 204 may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the embedding machine learning algorithm used to train the embedding machine learning model 204 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the embedding machine learning model 204 may take place as a dedicated training phase. In other example embodiments, the embedding machine learning model may be retrained dynamically at runtime based on feedback.

In an example embodiment, the embedding machine learning model is part of a Large Language Model (LLM). LLMs provide for natural language processing (NPL) of text, and rely on embeddings as part of its processing.

When a Generative Artificial Intelligence (GAI) model generates new, original data, it goes through the process of evaluating and classifying the data input to it. The product of this evaluation and classification is utilized to generate embeddings for data, which can then be later used to actually generate new data by the GAI model. In an example embodiment, however, the new, original data is either not generated or is irrelevant to the present solution. Rather, an embedding for the input piece of text is generated based on the intermediate work product of the GAI model that it would produce when going through the motions of generating the new, original data.

In an example embodiment, the embeddings may be obtained by sending the source code to an LLM along with a prompt requesting that the LLP group the domain manager source codes into multiple groups, making sure that the semantic coupling in the same group is the most, and the semantic coupling among different groups is the least.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

Referring back to FIG. 2, the embeddings are stored in a vector database 206. A domain manager organizer 208 then organizes the domain managers into K groups (where K is a configurable integer). This may be accomplished by retrieving the embeddings corresponding to the domain managers from the vector database 206 and then using a K-means clustering algorithm to organize the embeddings into the K-groups.

K-means is an algorithm which seeks to cluster input data into a number of groups, so that each of the data points belongs to a cluster, of which the cluster centers are calculated with respect to the various cluster members. The k-means process involves:
(1). Initialization: Choose the number of clusters (K) we want and randomly initialize the centroids of these clusters.
(2). Assignment: Assign each data point to the nearest centroid. The “nearest” here is usually defined by the Euclidean distance in the feature space.
(3). Update: Recalculate the centroids of each cluster after the assignment step. The new centroid is typically the mean value of all data points in the cluster.
(4). Iteration: Repeat the assignment and update steps until the centroids do not change significantly or a maximum number of iterations is reached.
(5). Evaluation: Evaluate the quality of the clusters, typically using measures like the silhouette score or the within-cluster sum of squares.

This process ensures that the algorithm keeps improving the quality of the clusters until it can no longer make significant improvements.

It should be noted that while k-means is described in this document in detail, it is possible for other clustering algorithms to be utilized in lieu of k-means clustering. Some other clustering algorithms that could be used include:

### 1) Hierarchical Clustering:

Builds a tree of clusters (dendrogram) either by merging (agglomerative) or splitting (divisive).
No need to specify the number of clusters in advance.
Suitable for smaller datasets due to higher computational cost.
   (2) DBSCAN (Density-Based Spatial Clustering of Applications with Noise):
Groups together points that are closely packed and marks points in low-density regions as outliers.
Doesn't require specifying the number of clusters and can identify arbitrarily shaped clusters.
Sensitive to the choice of parameters.

### (3) Gaussian Mixture Models (GMM):

Assumes that the data is generated from a mixture of several Gaussian distributions. Each cluster is represented by a Gaussian distribution, allowing for soft clustering. Can model elliptical clusters, unlike K-means.

### (4) Mean Shift:

A centroid-based algorithm that iteratively shifts points towards the mode of the data distribution.
Does not require the number of clusters to be specified beforehand.
Suitable for identifying clusters of arbitrary shapes.

### (5) Affinity Propagation:

Clusters data points based on the concept of “exemplars” without needing to specify the number of clusters.
Uses message passing between data points, allowing it to discover clusters based on data similarities.

### (6) Spectral Clustering:

Uses the eigenvalues of a similarity matrix to reduce dimensions before applying clustering techniques like K-means.
Effective for complex cluster structures.

### (7) Agglomerative Clustering:

Similar to hierarchical clustering, it starts with each point as its own cluster and merges them based on a linkage criterion.

### (8) OPTICS (Ordering Points To Identify the Clustering Structure):

A density-based clustering algorithm that creates an ordering of the data points to extract clusters of varying density.

Regardless of how the grouping occurs, once the domain managers are grouped into the multiple groups, entities of the persistence layer are assigned to the proper groups using the embeddings. One principle of microservices is Database per Service (one service has its own database). Thus, one database table (and its mapping entity) should only be owned by one microservice.

As the domain managers have been divided into K groups, each entity in the persistence layer should belong to the group to which it has the largest semantic coupling.

The cosine similarity between every entity entityᵢ and every vector of clustering center centerⱼ of domain manager group as

$${c}_{i , j} = \frac{{\sum }_{n = 1}^{N} ( {ve}_{i , n} \cdot {vc}_{j , n} )}{\sqrt{{\sum }_{n = 1}^{N} {( {ve}_{i , n} )}^{2}} \cdot \sqrt{{\sum }_{n = 1}^{N} {( {vc}_{j , n} )}^{2}}} , ( i ∈ [ 1 , Y ] , j ∈ [ 1 , K ] )$$

Where veᵢ=[ve_{i,1}, ve_{i,2}, ve_{i,3}, . . . , ve_{i,N}] is the embedded vector of entity entityᵢ, and vcⱼ=[vc_{j,1}, vc_{j,2}, vc_{j,3}, . . . , vc_{j,N}] is the embedded vector of clustering center centerⱼ of the domain manager group.

The center is the geometric center of the group of embeddings corresponding to the domain managers in the group.

Then entity entityᵢ (and its mapping database table) is assigned to the group groupₘₐₓ with the largest cosine similarity c_{i,max}. Then the entities have the largest semantic coupling to the assigned groups.

This may all be performed by entity assignor 210.

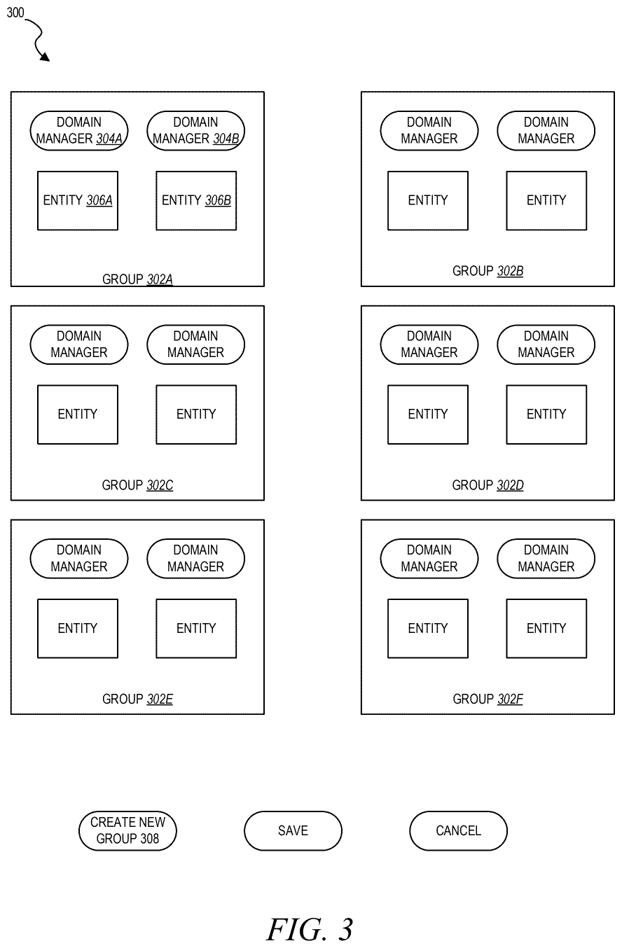

A user interface 212 may be provided to allow engineers to adjust the groups, if needed. There may be some domain-specific requirements that the engineers are aware of that affect the grouping of the domain managers and entities. Through the user interface 212, engineers can manually move domain managers and/or entities from one group to another or create a new group. This may be performed visually. FIG. 3 is a screen capture illustrating a user interface 300 for modifying groups of domain managers and entities in accordance with an example embodiment. The user interface 300 loads all the groups organized based on the domain manager organizer 208 and the entity assignor 210, and may display these groups 302A, 302B, 302C, 302D, 302E, 302F on the display, with domain managers and entities displayed visually within the groups 302A, 302B, 302C, 302D, 302E, 302F (such as domain manager 304A, domain manager 304B, entity 306A, and entity 306B all displayed in group 302A). The domain managers and entities can be dragged and dropped into different groups 302A, 302B, 302C, 302D, 302E, 302F, and a new group can be created using button 308 in which the domain managers and entities can be dragged and dropped.

A microservice creator 214 can then create microservices based on the groups. Specifically, each group can be used to create a different microservice.

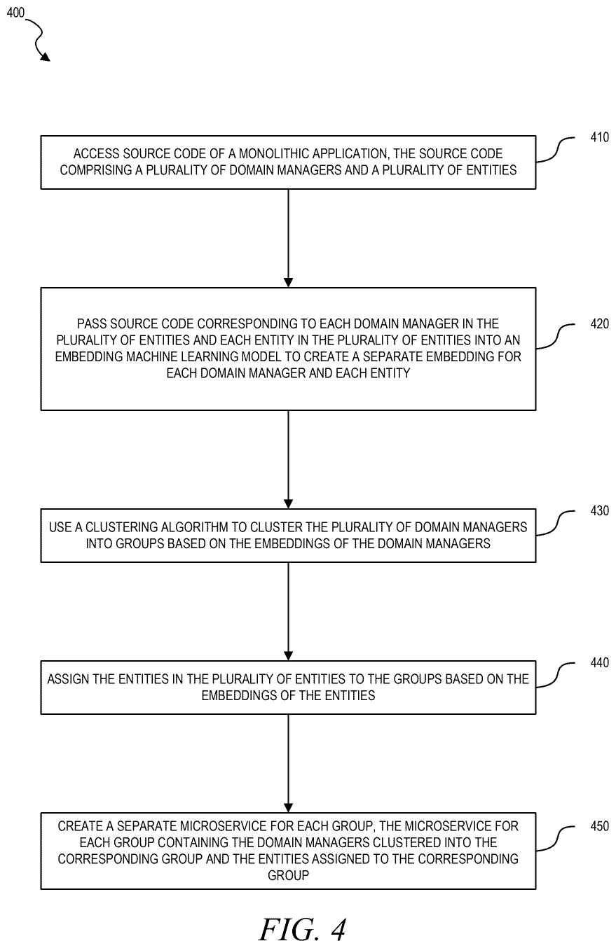

FIG. 4 is a flow diagram illustrating a method 400 for splitting an application in accordance with an example embodiment.

At operation 410, source code of a monolithic application is accessed. The source code comprises a plurality of domain managers and a plurality of entities.

At operation 420, source code corresponding to each domain manager in the plurality of entities and each entity in the plurality of entities is fed into an embedding machine learning model to create a separate embedding for each domain manager and each entity, the embedding comprising a coordinate in a latent n-dimensional space.

At operation 430, a clustering algorithm is used to cluster the plurality of domain managers into groups based on the embeddings of the domain managers.

At operation 440, the entities in the plurality of entities are assigned to the groups based on the embeddings of the entities.

At operation 450, a separate microservice is created for each group. The microservice for each group contains the domain managers clustered into the corresponding group and the entities assigned to the corresponding group.

In view of the disclosure above, various examples are set forth below. It should be noted that one or more features of an example, taken in isolation or combination, should be considered within the disclosure of this application.

Example 1 is a system comprising: at least one hardware processor; a non-tangible computer-readable medium storing instructions that, when executed by the at least one hardware processor, cause the at least one hardware processor to perform operations comprising: accessing source code of a monolithic application, the source code comprising a plurality of domain managers and a plurality of entities; passing source code corresponding to each domain manager in the plurality of entities and each entity in the plurality of entities into an embedding machine learning model to create a separate embedding for each domain manager and each entity, the embedding comprising a coordinate in a latent n-dimensional space; using a clustering algorithm to cluster the plurality of domain managers into groups based on the embeddings of the domain managers; assigning the entities in the plurality of entities to the groups based on the embeddings of the entities; and creating a separate microservice for each group, the microservice for each group containing the domain managers clustered into the corresponding group and the entities assigned to the corresponding group.

In Example 2, the subject matter of Example 1 comprises, wherein the embedding machine learning model is part of a Large Language Model (LLM).

In Example 3, the subject matter of Examples 1-2 comprises, wherein the clustering algorithm is a k-means algorithm.

In Example 4, the subject matter of Examples 1-3 comprises, wherein the assigning the entities comprises calculating, for each corresponding entity in the plurality of entity, a cosine similarity between an embedding for the corresponding entity and a center of a corresponding group.

In Example 5, the subject matter of Example 4 comprises, wherein the center of the corresponding group is a geometric center of embeddings corresponding to domain managers in the corresponding group.

In Example 6, the subject matter of Examples 1-5 comprises, wherein the operations further comprise: providing a user interface where users can modify which group an entity and/or domain manager is assigned to.

In Example 7, the subject matter of Example 6 comprises, wherein the user interface further comprises a mechanism for users to add a new group.

Example 8 is a method comprising: accessing source code of a monolithic application, the source code comprising a plurality of domain managers and a plurality of entities; passing source code corresponding to each domain manager in the plurality of entities and each entity in the plurality of entities into an embedding machine learning model to create a separate embedding for each domain manager and each entity, the embedding comprising a coordinate in a latent n-dimensional space; using a clustering algorithm to cluster the plurality of domain managers into groups based on the embeddings of the domain managers; assigning the entities in the plurality of entities to the groups based on the embeddings of the entities; and creating a separate microservice for each group, the microservice for each group containing the domain managers clustered into the corresponding group and the entities assigned to the corresponding group.

In Example 9, the subject matter of Example 8 comprises, wherein the embedding machine learning model is part of a Large Language Model (LLM).

In Example 10, the subject matter of Examples 8-9 comprises, wherein the clustering algorithm is a k-means algorithm.

In Example 11, the subject matter of Examples 8-10 comprises, wherein the assigning the entities comprises calculating, for each corresponding entity in the plurality of entity, a cosine similarity between an embedding for the corresponding entity and a center of a corresponding group.

In Example 12, the subject matter of Example 11 comprises, wherein the center of the corresponding group is a geometric center of embeddings corresponding to domain managers in the corresponding group.

In Example 13, the subject matter of Examples 8-12 comprises, providing a user interface where users can modify which group an entity and/or domain manager is assigned to.

In Example 14, the subject matter of Example 13 comprises, wherein the user interface further comprises a mechanism for users to add a new group.

Example 15 is a non-transitory machine-readable medium storing instructions which, when executed by one or more processors, cause the one or more processors to perform operations comprising: accessing source code of a monolithic application, the source code comprising a plurality of domain managers and a plurality of entities; passing source code corresponding to each domain manager in the plurality of entities and each entity in the plurality of entities into an embedding machine learning model to create a separate embedding for each domain manager and each entity, the embedding comprising a coordinate in a latent n-dimensional space; using a clustering algorithm to cluster the plurality of domain managers into groups based on the embeddings of the domain managers; assigning the entities in the plurality of entities to the groups based on the embeddings of the entities; and creating a separate microservice for each group, the microservice for each group containing the domain managers clustered into the corresponding group and the entities assigned to the corresponding group.

In Example 16, the subject matter of Example 15 comprises, wherein the embedding machine learning model is part of a Large Language Model (LLM).

In Example 17, the subject matter of Examples 15-16 comprises, wherein the clustering algorithm is a k-means algorithm.

In Example 18, the subject matter of Examples 15-17 comprises, wherein the assigning the entities comprises calculating, for each corresponding entity in the plurality of entity, a cosine similarity between an embedding for the corresponding entity and a center of a corresponding group.

In Example 19, the subject matter of Example 18 comprises, wherein the center of the corresponding group is a geometric center of embeddings corresponding to domain managers in the corresponding group.

In Example 20, the subject matter of Examples 15-19 comprises, wherein the operations further comprise: providing a user interface where users can modify which group an entity and/or domain manager is assigned to.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

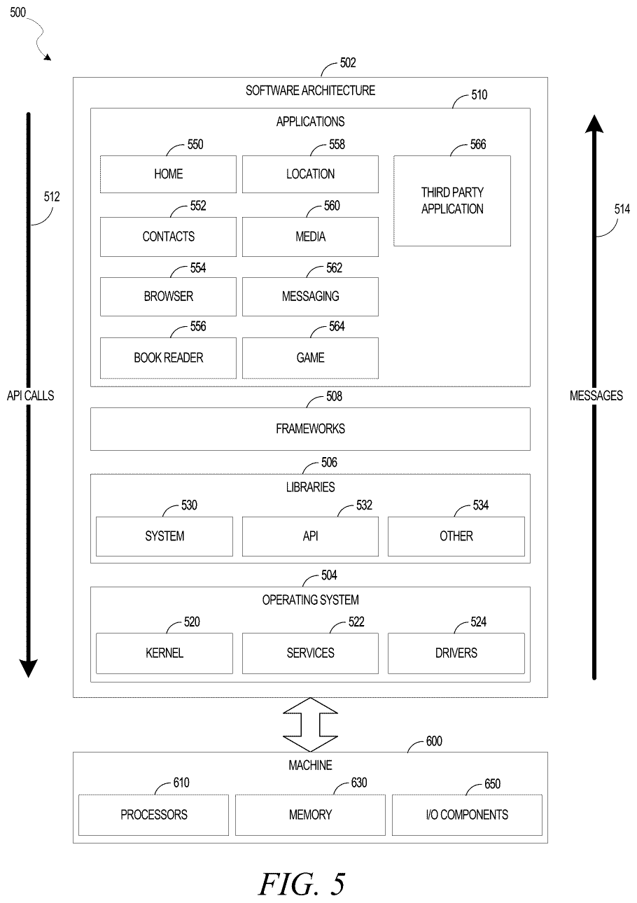

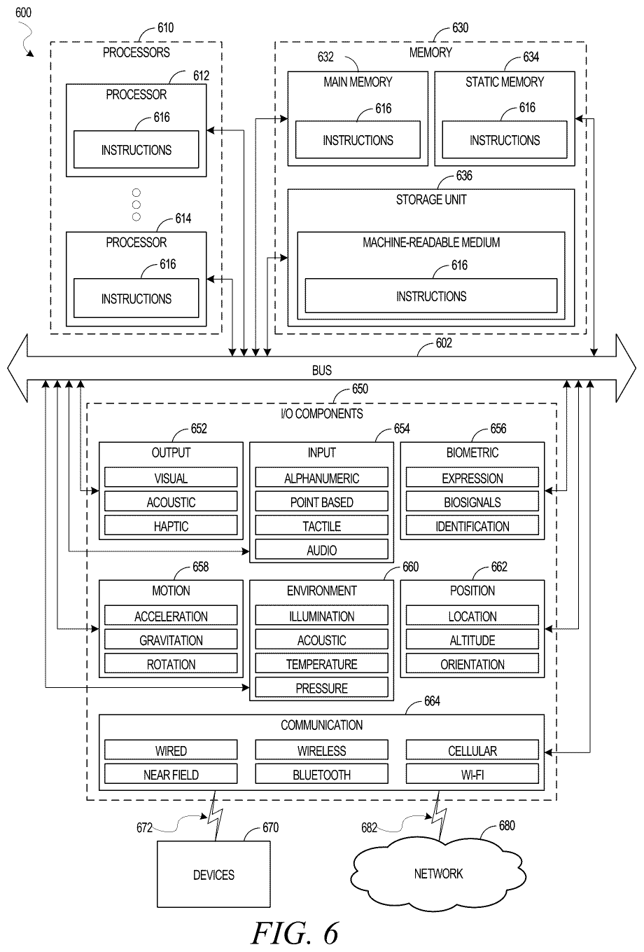

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that comprises processors 610, memory 630, and input/output (I/O) components 650. In this example architecture, the software architecture 502 can be conceptualized as a stack of layers where each layer may provide a particular functionality. For example, the software architecture 502 comprises layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 comprises, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware, according to some embodiments. For instance, the drivers 524 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can comprise system libraries 530 (e.g., C standard library) that can provide functions such as memory allocation functions, string manipulation functions, mathematic functions, and the like. In addition, the libraries 506 can comprise API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also comprise a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 comprise a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to comprise a collection of machines 600 that individually or jointly execute the instructions 616 to perform any one or more of the methodologies discussed herein.

The machine 600 may comprise processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may comprise, for example, a processor 612 and a processor 614 that may execute the instructions 616. The term “processor” is intended to comprise multi-core processors that may comprise two or more independent processors (sometimes referred to as “cores”) that may execute instructions 616 contemporaneously. Although FIG. 6 shows multiple processors 610, the machine 600 may comprise a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may comprise a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may comprise a wide variety of components to receive input, provide output, produce output, transmit information, exchange information, capture measurements, and so on. The specific I/O components 650 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 650 may comprise many other components that are not shown in FIG. 6. The I/O components 650 are grouped according to functionality merely for simplifying the following discussion, and the grouping is in no way limiting. In various example embodiments, the I/O components 650 may comprise output components 652 and input components 654. The output components 652 may comprise visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may comprise biometric components 656, motion components 658, environmental components 660, or position components 662, among a wide array of other components. For example, the biometric components 656 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may comprise acceleration sensor components (e.g., accelerometer), gravitation sensor components, rotation sensor components (e.g., gyroscope), and so forth. The environmental components 660 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may comprise communication components 664 operable to couple the machine 600 to a network 680 or devices 670 via a coupling 682 and a coupling 672, respectively. For example, the communication components 664 may comprise a network interface component or another suitable device to interface with the network 680. In further examples, the communication components 664 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or comprise components operable to detect identifiers. For example, the communication components 664 may comprise radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (e.g., 630, 632, 634, and/or memory of the processor[s] 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may comprise a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component comprised in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 616 for execution by the machine 600, and comprise digital or analog communications signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor;
a non-tangible computer-readable medium storing instructions that, when executed by the at least one hardware processor, cause the at least one hardware processor to perform operations comprising:
accessing source code of a monolithic application, the source code comprising a plurality of domain managers and a plurality of entities;
passing source code corresponding to each domain manager in the plurality of entities and each entity in the plurality of entities into an embedding machine learning model to create a separate embedding for each domain manager and each entity, the embedding comprising a coordinate in a latent n-dimensional space;
using a clustering algorithm to cluster the plurality of domain managers into groups based on the embeddings of the domain managers;
assigning the entities in the plurality of entities to the groups based on the embeddings of the entities; and
creating a separate microservice for each group, the microservice for each group containing the domain managers clustered into the corresponding group and the entities assigned to the corresponding group.

2. The system of claim 1, wherein the embedding machine learning model is part of a Large Language Model (LLM).

3. The system of claim 1, wherein the clustering algorithm is a k-means algorithm.

4. The system of claim 1, wherein the assigning the entities comprises calculating, for each corresponding entity in the plurality of entity, a cosine similarity between an embedding for the corresponding entity and a center of a corresponding group.

5. The system of claim 4, wherein the center of the corresponding group is a geometric center of embeddings corresponding to domain managers in the corresponding group.

6. The system of claim 1, wherein the operations further comprise:
providing a user interface where users can modify which group an entity and/or domain manager is assigned to.

7. The system of claim 6, wherein the user interface further comprises a mechanism for users to add a new group.

8. A method comprising:
accessing source code of a monolithic application, the source code comprising a plurality of domain managers and a plurality of entities;
passing source code corresponding to each domain manager in the plurality of entities and each entity in the plurality of entities into an embedding machine learning model to create a separate embedding for each domain manager and each entity, the embedding comprising a coordinate in a latent n-dimensional space;
using a clustering algorithm to cluster the plurality of domain managers into groups based on the embeddings of the domain managers;
assigning the entities in the plurality of entities to the groups based on the embeddings of the entities; and
creating a separate microservice for each group, the microservice for each group containing the domain managers clustered into the corresponding group and the entities assigned to the corresponding group.

9. The method of claim 8, wherein the embedding machine learning model is part of a Large Language Model (LLM).

10. The method of claim 8, wherein the clustering algorithm is a k-means algorithm.

11. The method of claim 8, wherein the assigning the entities comprises calculating, for each corresponding entity in the plurality of entity, a cosine similarity between an embedding for the corresponding entity and a center of a corresponding group.

12. The method of claim 11, wherein the center of the corresponding group is a geometric center of embeddings corresponding to domain managers in the corresponding group.

13. The method of claim 8, further comprising:
providing a user interface where users can modify which group an entity and/or domain manager is assigned to.

14. The method of claim 13, wherein the user interface further comprises a mechanism for users to add a new group.

15. A non-transitory machine-readable medium storing instructions which, when executed by one or more processors, cause the one or more processors to perform operations comprising:
accessing source code of a monolithic application, the source code comprising a plurality of domain managers and a plurality of entities;
passing source code corresponding to each domain manager in the plurality of entities and each entity in the plurality of entities into an embedding machine learning model to create a separate embedding for each domain manager and each entity, the embedding comprising a coordinate in a latent n-dimensional space;
using a clustering algorithm to cluster the plurality of domain managers into groups based on the embeddings of the domain managers;
assigning the entities in the plurality of entities to the groups based on the embeddings of the entities; and
creating a separate microservice for each group, the microservice for each group containing the domain managers clustered into the corresponding group and the entities assigned to the corresponding group.

16. The non-transitory machine-readable medium of claim 15, wherein the embedding machine learning model is part of a Large Language Model (LLM).

17. The non-transitory machine-readable medium of claim 15, wherein the clustering algorithm is a k-means algorithm.

18. The non-transitory machine-readable medium of claim 15, wherein the assigning the entities comprises calculating, for each corresponding entity in the plurality of entity, a cosine similarity between an embedding for the corresponding entity and a center of a corresponding group.

19. The non-transitory machine-readable medium of claim 18, wherein the center of the corresponding group is a geometric center of embeddings corresponding to domain managers in the corresponding group.

20. The non-transitory machine-readable medium of claim 15, wherein the operations further comprise:
providing a user interface where users can modify which group an entity and/or domain manager is assigned to.
